(19) United States
(12) Patent Application Publication
(10) Pub. No.: US 2020/0008616 A1
(43) Pub. Date: Jan. 9, 2020

(54) Housing with Moisture Prevention Channel

(71) Applicant: NuWave, LLC, Libertyville, IL (US)

(72) Inventor: Jung S. Moon, Long Grove, IL (US)

(21) Appl. No.: 16/504,653

(22) Filed: Jul. 8, 2019

Related U.S. Application Data
(60) Provisional application No. 62/694,591, filed on Jul. 6, 2018.

(51) Int. Cl. A47J 37/06; A47J 36/38

(52) U.S. Cl. CPC A47J 37/0641; A47J 36/38; A47J 37/0664

(57) ABSTRACT

An air fryer housing having top or side air openings allows air to freely enter the system while both preventing liquids from entering the electronics and removing liquids which enter the housing. Liquids which find a way through an initial outer set of air openings, collect in a channel within the housing instead of passing with air flow into a second set of openings on an interior surface. The collected liquids are prevented from reaching any electrical or mechanical components of the system. The liquid may be pooled within the channel or drained to an exterior of the fryer from a discharge port in the bottom of the fryer. Alternately, the liquid is left to eventually evaporate from the liquid channel.

### RELATED APPLICATION

The present application claims the filing priority of U.S. Provisional Application No. 62/694,591 titled “Air Fryer Housing with Moisture Prevention Vents” and filed on Jul. 6, 2018. The '591 Provisional Application is hereby incorporated by reference.

### TECHNICAL FIELD OF THE INVENTION

The present application relates to cooking appliances, particularly, electric cooking appliances. More specifically, the application relates to a cooking appliance housing and a method for preventing moisture egress to an interior cavity of appliance. Most specifically, the disclosed invention relates to a housing for an electric air fryer.

### BACKGROUND. OF THE INVENTION

An air fryer is a kitchen appliance that cooks by rapidly circulating hot air around food within a basket positioned in a cooking chamber. Some air fryers may come with adjustable temperature and timer knobs that allow for more precise cooking. Typically, heat is created by a heating coil and a mechanical fan drives heated air downward, where it disperses and circulates around food in a removable drawer as it moves back upward, all at high-speed. This cooking method produces a crispy layer on the food thanks to Maillard reactions.

By creating and circulating heated air at temperatures of up to 200° C. (about 392° F.), the air fryer is able to cook foods like potato chips, chicken, fish, pastries and more using much less oil than a traditional deep-fryer. Various brands of air fryers claim to use as much as 80% less cooking oil in comparison to traditional deep-fryers.

By using less oil to air fry foods, air fryers become a healthier alternative to traditional deep-fried foods. Reports show that eating deep-fried foods can increase the risk of cardiovascular diseases, hypertension, diabetes, cancer and obesity. Even so, some people have been concerned that this healthier form of cooking will result in poorer taste, look and texture of traditional recipes. However, a study published in the Journal of Food and Nutrition Sciences show that fries cooked using an air fryer actually beat traditional deep-fried potatoes in the categories of taste, color, smell, crispness, hardness, and oiliness and were only rated worse than traditional deep-fried potatoes in appearance.

That said, air fryers are not without disadvantages. For example, unlike some deep fryers, air frying must occur in a closed space for proper temperature control. This can make the monitoring of cooking foods in an air fryer difficult. Further, unlike deep fryers, which immerse foods into hot oil, air fryers rely on the movement of heated air. Having adequate channels to move this air through the cooking space so that it achieves proper heat distribution has been a challenge for air fryer designers and manufacturers. Improper heat distribution results in foods with both overcooked and undercooked portions. Of course, not unlike traditional deep-fryers, air fryers operating at such high-temperatures can create safety issues, as well. Especially in the event of overheating of the fryer.

Further, in order to maintain a heated air flow within the cooking chamber, air fryers need to pull air into the system to be heated and circulated. A plurality of exterior air intake openings is typically provided on an upper surface of a fryer housing and leading to the heating element. Unfortunately, in addition to pulling in ambient air these opening make air fryers susceptible to the ingress of unwanted liquids, such as water, cooking oil, etc. Liquids which infiltrate the fryer housing could reach the critical electronics of the system, causing widespread failures.

Until the invention of the present application, these and other problems in the prior art went either unnoticed or unsolved by those skilled in the art. The present invention provides an air fryer which performs multiple functions without sacrificing quality, reliability, design or affordability.

### SUMMARY OF THE INVENTION

There is disclosed herein an improved appliance housing which avoids the disadvantages of prior devices while affording additional structural and operating advantages.

Generally speaking, the subject housing comprises a top surface and a plurality of substantially vertical side surfaces, a plurality of first air openings positioned in and passing through at least one of the plurality of side surfaces (alternatively or additionally, in the top surface), a plurality of second air openings positioned in and passing through an interior surface, a passage fluidly connecting the first and second air openings, and a channel positioned within the passage.

In a specific embodiment, the plurality of vertical side surfaces each have an outer face and an'inner face, and the first air openings open into a fluid passage within the housing defined by the inner face of the plurality of side surfaces and the substantially vertical interior surface. The plurality of second air openings are substantially below a horizontal plane defined by the plurality of first air openings and the channel is positioned below both such that liquid passing through the first air openings into the passage will fall into the channel before reaching the second air opening.

In a preferred embodiment, the air fryer housing further comprises a drain opening in the channel. Liquid reaching the channel is drained through the drain opening to an exit port, preferably positioned in a base of the fryer housing.

Alternatively, the channel may be configured to retain liquid therein. It presumably will evaporate over time or may be cleaned through a suitable process.

In still another alternate embodiment, the channel may be angled to flow liquid to an exit opening.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated by those of ordinary skill in the art.

FIGS. 1-7 are top perspective views of different air fryer systems having an inlet and/or air vents which may allow liquid to infiltrate the fryer housing;

FIG. 8a is a schematic illustration of an embodiment of an anti-liquid channel used in the present air fryer system;

FIG. 8b is a cross-sectional view of the illustration of FIG. 8a;

FIG. 9a is a schematic illustration of an alternate embodiment of an anti-liquid channel used in the present air fryer system; and

FIG. 9b is a cross-sectional view of the illustration of FIG. 9a.

### DETAILED DESCRIPTION OF PREFERRED EMBODIMENTS

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to embodiments illustrated.

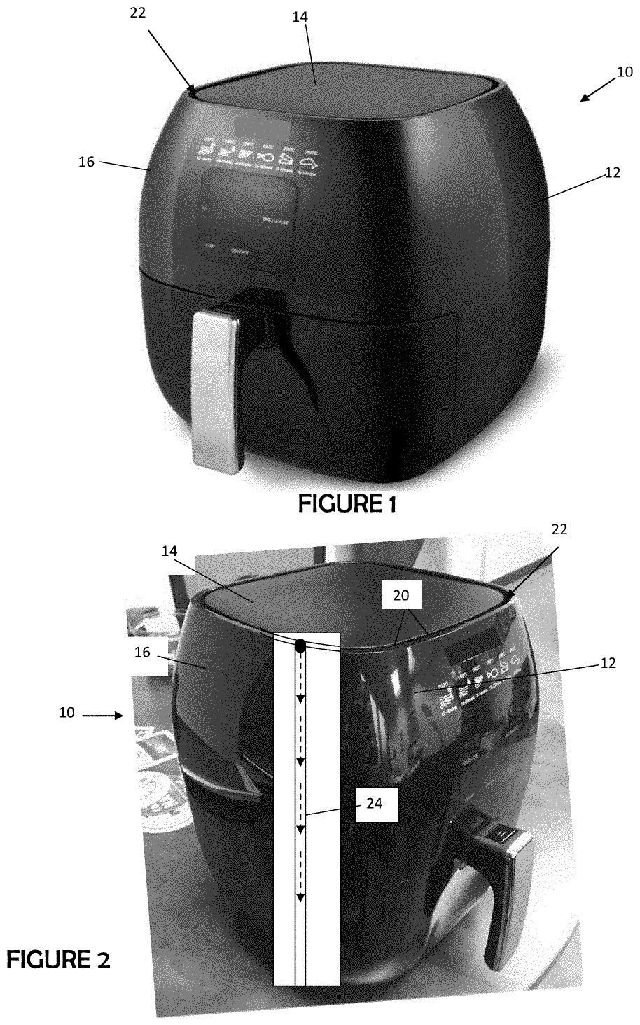

Referring to FIGS. 1-7, there is illustrated cooking appliances, specifically air fryers, generally designated by the numeral 10. Each particularly illustrated air fryer 10 is for a providing a fried food product made using high-velocity heated air. However, while all the embodiments illustrated and described herein are directed to an air fryer 10, it should be understood that the principles of the invention can be more broadly applied to cooking appliances, as well as other types of electric appliances with air vents or openings that may provide an ingress for liquids. Such appliances may include convection ovens, toasters, coffee machines, beverage makers, ice makers, and the like.

As can be seen in FIGS. 1-7, the various air fryers 10 include, a housing 12, having a top surface 14 and side surfaces 16. Typically, within the housing 12 are electronics and components which may be negatively affected by water and other liquids. However, openings 20 within the housing 12 are required for pulling in air to be heated in the cooking process.

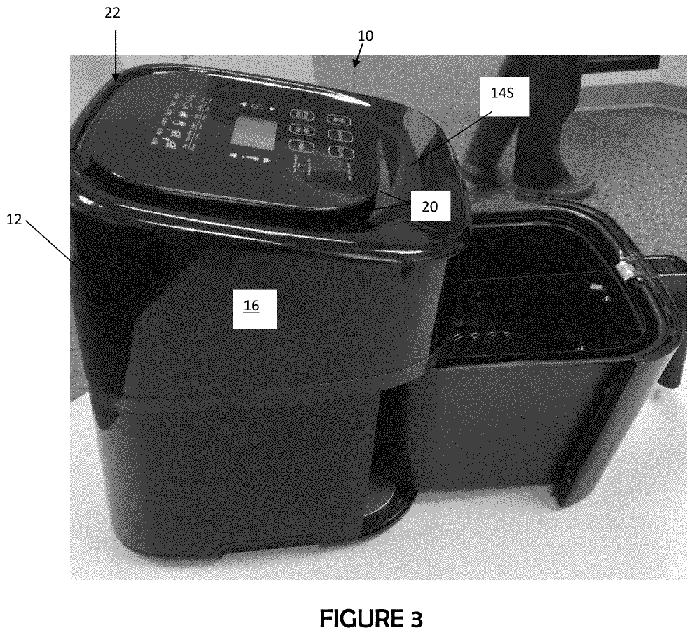

As shown in FIGS. 1-3, prior cooking systems having openings on a top surface 14 have attempted to solve the problem of liquids, such as water, dripping down into the fryer housing 12 by using a moisture trough 22. The trough 22 is built into the top surface 14 and is intended to channel liquids to strategically placed openings 20 which drain off the liquid through a connected hose 24. The hose 24 is typically positioned within the housing 12 to lead through the system and expel the liquid from a port (not shown) in the bottom of the fryer 10. A sloping top surface 14S, as shown in FIG. 3, is intended to further facilitate channeling of liquids away from openings at the higher end of the top surface 14S. While this system is effective at removing liquids, it does not prevent liquids from entering air openings 20.

Conversely, the present air fryer housing 112 includes a tortuous air pathway which allows necessary ambient air to be pulled into the fryer 110 without allowing harmful liquids to reach electrical components housed within the system.

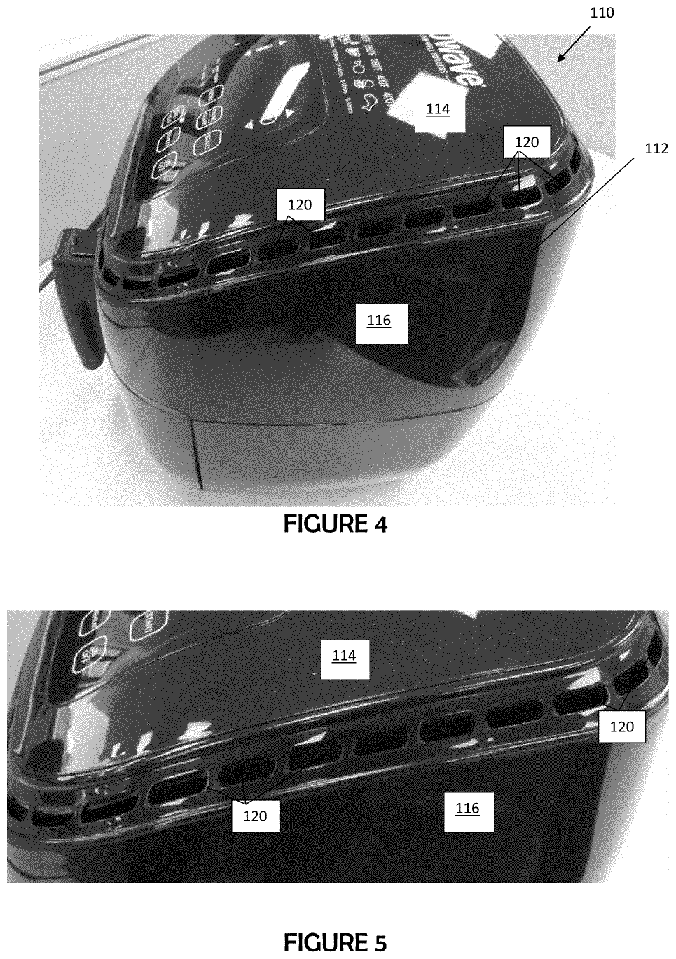

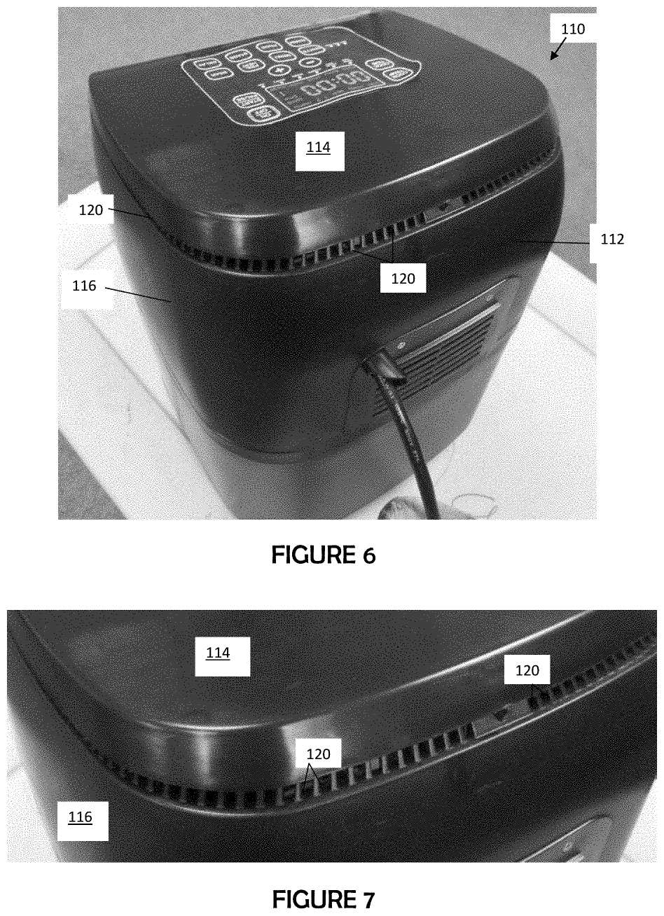

Referring to FIGS. 4-7, two embodiments of an air fryer system are shown. In each embodiment, air openings 120 are placed along either a top (i.e., substantially upward facing) surface 114, as shown in FIGS. 4 and 5, or at least one side (i.e., substantially vertical) surface 116, as shown in FIGS. 6 and 7. In the disclosed air fryers 110, the openings 120 are critical to drawing ambient air into the system where it can be heated and circulated. Other appliances may use the air for cooling or other purposes.

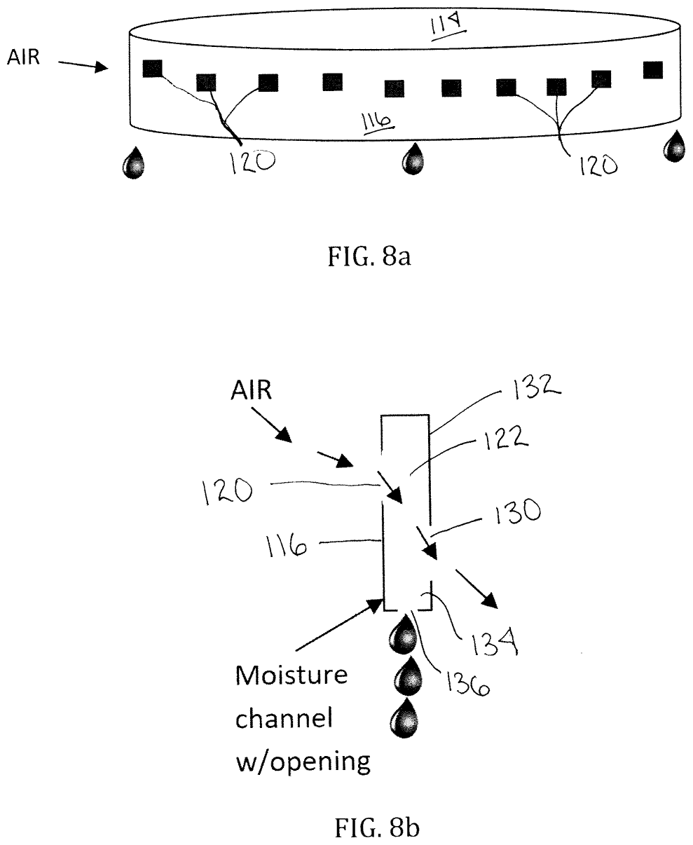

As illustrated in FIGS. 8a and 8b, the openings 120 lead to a passage 122 within the housing 10 that, in turn, leads to a second set of openings 130 in an interior substantially vertical wall surface 132. Air flows readily into the passage 122 from the first openings 120 and then into the second openings 130 to a heating element (not shown). A channel 134 positioned below both sets of openings, 120 and 130, acts to collect any fluid which may find its way into openings 120. Gravity prevents these liquids from traveling directly to the second set of openings 130.

The channel 134 should be deep enough to collect a substantial amount of fluid. A small drain port 136 in the base of the channel 134 directs the accumulating fluid through a tube or other path out the bottom of the housing 110.

Specifically, in the cross-sectional view of FIG. 8b, air flow is pulled into the first openings 120 on the side (or top) of the air fryer housing 112. The air enters the passage 122 and is pulled further into the housing 112 through second interior openings 130. However, heavier liquids which may find their way into the first outer openings 120 are deposited in the channel 134. As the liquids pool in the channel 134 they will eventually drain out the strategically placed port 136 in the bottom of the channel 134 which leads out of the fryer housing 112.

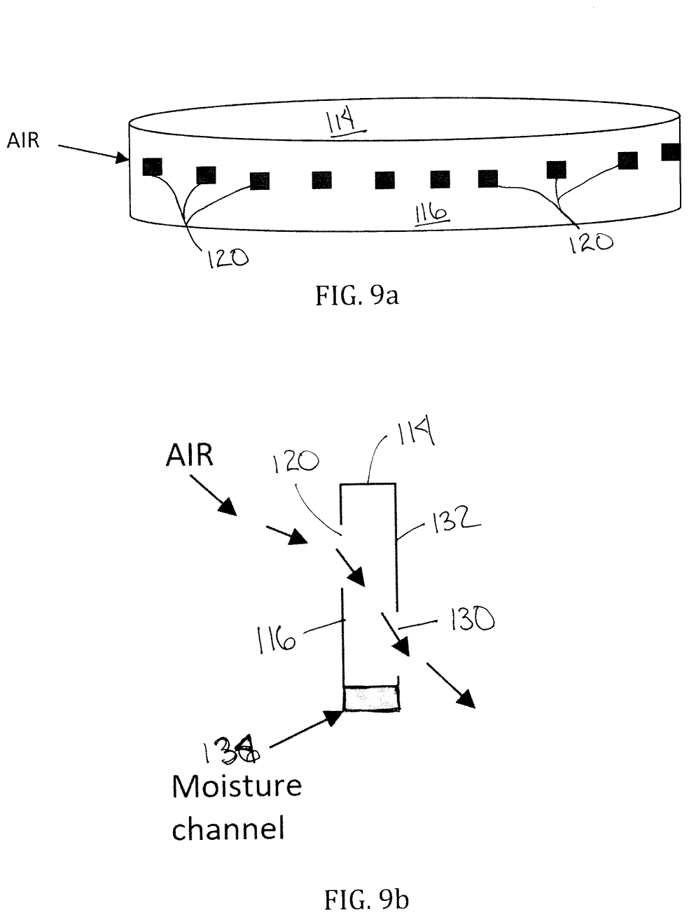

As shown in FIGS. 9a and 9b, an alternate embodiment, the channel 134 may be closed and merely allow accumulated moisture to evaporate over time. In such a case, the channel 134 may need to be slightly deeper to prevent liquids from spilling into the second openings 130.

The matter set forth in the foregoing description and accompanying drawings is offered by, way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An air fryer housing comprising:
a top surface and a plurality of substantially vertical side surfaces each having an outer face and an inner face;
a plurality of first air openings positioned in and passing through at least one of the plurality of side surfaces from the outer to the inner face and opening into a fluid passage within the housing defined by the inner face of the plurality of side surfaces and a substantially vertical interior surface;
a plurality of second air openings positioned in and passing through the interior surface, wherein the plurality of second air openings are substantially below a horizontal plane defined by the plurality of first air openings; and
a channel positioned within the passage below both the plurality of first air openings and the plurality of second air openings such that liquid passing through the first air openings into the passage will fall into the channel before reaching the second air opening.

2. The air fryer housing of claim 1, further comprising a drain opening in the channel.

3. The air fryer housing of claim 1, wherein the plurality of first air openings are positioned on each of the plurality of side surfaces of the air fryer housing.

4. The air fryer housing of claim 2, wherein liquid reaching the channel is drained through the drain opening to an exit port.

5. The air fryer housing of claim 4, wherein the exit port is positioned in a base of the fryer housing.

6. The air fryer housing of claim 1, wherein the channel is configured to retain liquid therein.

7. The air fryer housing of claim 1, wherein the channel is angled to flow liquid to an exit opening.

8. The air fryer housing of claim 1, wherein the plurality of first air openings are positioned on the top surface of the housing.

9. The air fryer housing of claim 8, further comprising a drain opening in the channel.

10. The air fryer housing of claim 9, wherein liquid reaching the channel is drained through the drain opening to an exit port.

11. The air fryer housing of claim 10, wherein the exit port is positioned in a base of the fryer housing.

12. The air fryer housing of claim 8, wherein the channel is configured to retain liquid therein.

13. An electric cooking appliance housing comprising:
a top surface and a plurality of substantially vertical side surfaces each having an outer face and an inner face;
a plurality of first air openings positioned in and passing through at least one of the plurality of side surfaces from the outer to the inner face and opening into a fluid passage within the housing defined by the inner face of the plurality of side surfaces and a substantially vertical interior surface;
a plurality of second air openings positioned in and passing through the interior surface, wherein the plurality of second air openings are substantially below a horizontal plane defined by the plurality of first air openings; and
a channel positioned within the passage below both the plurality of first air openings and the plurality of second air openings such that liquid passing through the first air openings into the passage will fall into the channel before reaching the second air opening.
